(19) United States
(12) Patent Application Publication
(10) Pub. No.: US 2005/0224577 A1
(43) Pub. Date: Oct. 13, 2005

(54) Method and apparatus for automated identifying, monitoring the use of, and assessing the effective life span of process manufacturing components

(76) Inventors: Gary David Rozenblat, Sherman Oaks, CA (US); George Younan, Northridge, CA (US)

Correspondence Address: Gary Rozenblat, 21935 Plummer Street, Chatsworth, CA, 91311, US

(21) Appl. No.: 11/102,324

(22) Filed: Apr. 8, 2005

Related U.S. Application Data
(60) Provisional application No. 60/560,056, filed on Apr. 8, 2004.

(51) Int. Cl. G06F 17/60

(52) U.S. Cl. 235/385

(57) ABSTRACT

An automated, adaptive method and apparatus for identification of, monitoring the usage of, and assessing the effective life span of degradable process manufacturing components. The apparatus consists of an inexpensive, miniature sensing and recording device, containing a unique electronic identifier, a wireless transmission device, a wireless receiving device, a computer database and software program to specify life span determination rules and apply them to component database records. The sensing and recording device is affixed to the component, which is to be tracked and monitored, for the life of the component. A software program, preferably with a Web browser interface provides a user interface, which allows an end user to define a set of rules to be applied to each component record to determine if the component's life span has been exceeded.

### CROSS REFERENCE TO RELATED APPLICATION(S)

This application claims the benefit of U.S. provisional application no. 60/560,056, filed Apr. 8, 2004, which is incorporated by reference as if fully set forth.

### BACKGROUND

The present invention relates to an automated usage tracking and life expectancy determination of process manufacturing components. The invention addresses and important problem of accurately tracking the use of critical manufacturing components necessary to make timely replacements and avoid unexpected costly component failures. The present invention is particularly relevant to process manufacturing in the pharmaceutical and biotechnology fields where manufacturing practices are tightly regulated and the tolerance for risk is extremely low.

High purity process manufacturing involves the processing of raw materials, typically liquids or powders, into a final, human consumable product, in a government regulated, ultra clean environment. Industries typically associated with high purity process manufacturing are the pharmaceutical, biotechnology, and food and beverage industries. Process manufacturers utilize complex, costly processing systems comprised of components such as tanks, valves, piping, hoses, etc. High purity process manufacturing quality assurance is particularly demanding as it is government regulated and all systems, processes and materials must adhere to strict guidelines of quality and integrity.

A large high purity manufacturer, particularly in biotechnology, where small batches of very costly product are manufactured, may utilize thousands of custom fabricated components, which are assembled into processing systems, on demand. Such systems are utilized to manufacture a single batch of product and must be cleaned before utilized again. Both cleaning and normal use subject components to harsh conditions, such as extreme heat (dry oven or steam autoclave), cold, and humidity. Different materials react and degrade in a different ways when subjected to similar conditions and many, such as silicone rubber, have limited useful life spans, which are determined by exposure to extreme conditions. In fact, a processing system's validation protocol may call out a maximum number of autoclave cycles to which a particular component may be subjected, before it must be replaced.

Furthermore, high purity manufacturing components are costly as they are fabricated from specialty materials prescribed by the FDA, such as high grade stainless steel, silicone, etc. The components are utilized to produce costly products via a very regimented and validated process, where specific components must be used for their prescribed applications. As a result, precise identification of components is necessary to avoid mistakes. In addition, components must be in excellent working condition to insure that the highest level of quality and control is maintained throughout the manufacturing process. Thus, the ability- to track usage of each individual component to correctly determine its useful life span is extremely advantageous.

Currently, process components are seldom tracked by electronic means. Some manufacturers use ad hoc tracking systems consisting of color-coding or human readable labels with manufacture date. These methods include those specifically designed for the high purity application, such as NewAge Industries AdvantaLABEL® which encloses a human readable identification label in vulcanized silicone rubber, effectively bonding it to the silicone hose it identifies. More advanced systems use barcodes and scanners to allow manual identification and tracking. Finally, most novel existing approaches utilize RFID tags affixed to components to allow for electronic identification with an RFID reader at various degrees of proximity to the tagged component. NewAge Industries HoseTrack® is system utilizing RFID affixed to sanitary hose assemblies for the purpose of identification and tracking.

In our view, all of the current solutions are insufficient. While offering varying degrees of identification, the current solutions all rely on a manual means of tracking the usage and exposure of a component to those conditions and actions that directly affect its effective and safe life span. This is inherently error prone, unreliable and defies validation.

### SUMMARY

The present invention facilitates the identification, and automated usage tracking and life span determination of process manufacturing components. The system includes an inexpensive, miniature ID and sensing device imbedded in or attached to a manufacturing component of interest. The sensing device is comprised of read-only-memory containing a unique identification code, one or more sensors (e.g. temperature, humidity, etc.), clock, memory for the storage of successive, time stamped sensor readings, and a power source. In one preferred embodiment, the sensing device contains a wireless communications module and transmitter. In another, the sensing unit contains a communications module with terminals for tactile probe.

The sensing device periodically senses its environment, recording the time, date and the sensor data in its memory. A number of readings are capable of being stored, limited by the amount of memory contained within the device. In one embodiment, the sensing unit periodically transmits the sensor data in its memory and its unique ID, wirelessly, to one or more receiving devices. In another embodiment, the sensing device memory and its unique ID are read via a tactile probe reader, such as a PDA equipped with such a probe. Such manual downloads may occur on scheduled maintenance cycles performed frequently enough to capture all sensor data prior to the sensing device memory becoming full.

The reading device or the wireless receiver, which collect the sensor data from one or more sensing units associate the sensor data with the unique ID of the sensing device. The receiving device is connected to a computer network, either private or the Internet, and communicates with a database server. The database server stores all sensed data and correlates the unique ID of the sensing device with a process manufacturing component record.

A computer program allows users to set up rules for determining the effective lifespan of a manufacturing component based on its static characteristics (e.g. date of manufacture, material of construction, intended application, etc.), sensor data, and known life span of similar components. It is thus adaptive, meaning the rules may reference previous decision data to make new decisions.

The rules are applied to each tracked component periodically to identify those, which may need replacement or maintenance. Automatic reports and alerts are generated and transmitted via email another electronic notification system to the user. In one embodiment, an alert generates an automatic re-order of the component via an interface to an electronic purchasing system.

### BRIEF DESCRIPTION OF THE DRAWINGS

The foregoing Summary and the following detailed description will be better understood when read in conjunction with the following drawings, which illustrate preferred embodiments of the invention. In the drawings:

FIG. 1 is a schematic view showing the component life span determination system in accordance with a preferred embodiment of the present invention.

FIG. 2 is a schematic view showing the component life span determination system in accordance with an embodiment of the present invention utilizing a tactile probe reader.

FIG. 3 is a block diagram showing the architecture of the sensing unit in accordance with a preferred embodiment of the present invention shown in FIG. 1.

FIG. 4 is a block diagram showing the architecture of the sensing unit in accordance with an embodiment of the present invention shown in FIG. 2.

### DETAILED DESCRIPTION OF THE PREFERRED EMBODIMENT(S)

Certain terminology is used in the following description for convenience only and is not limiting.

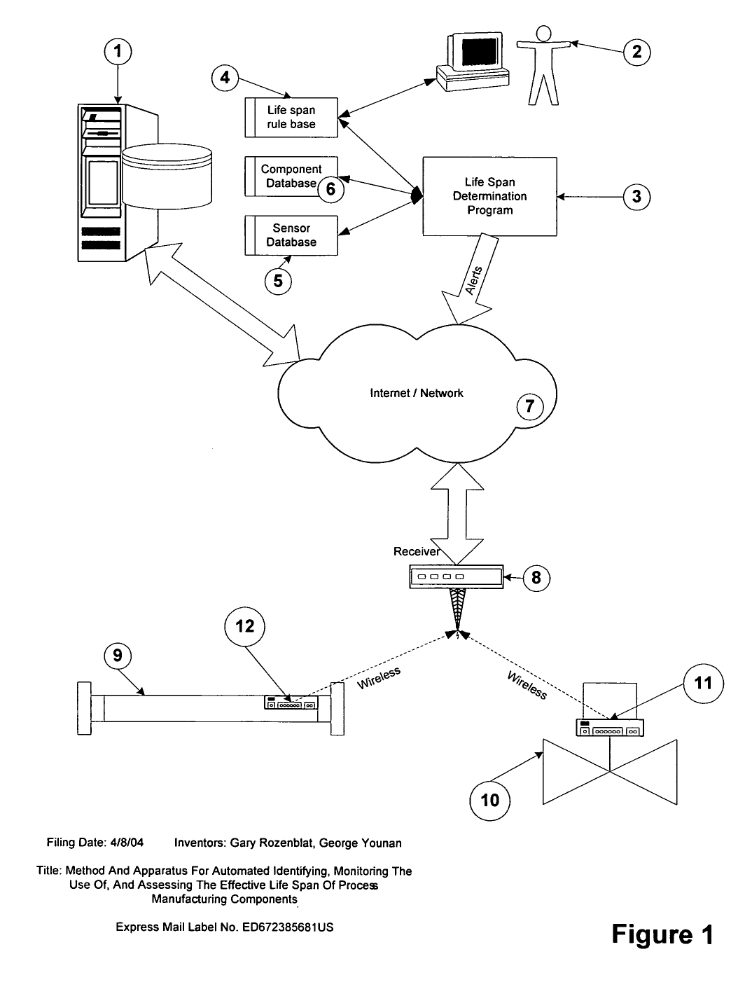

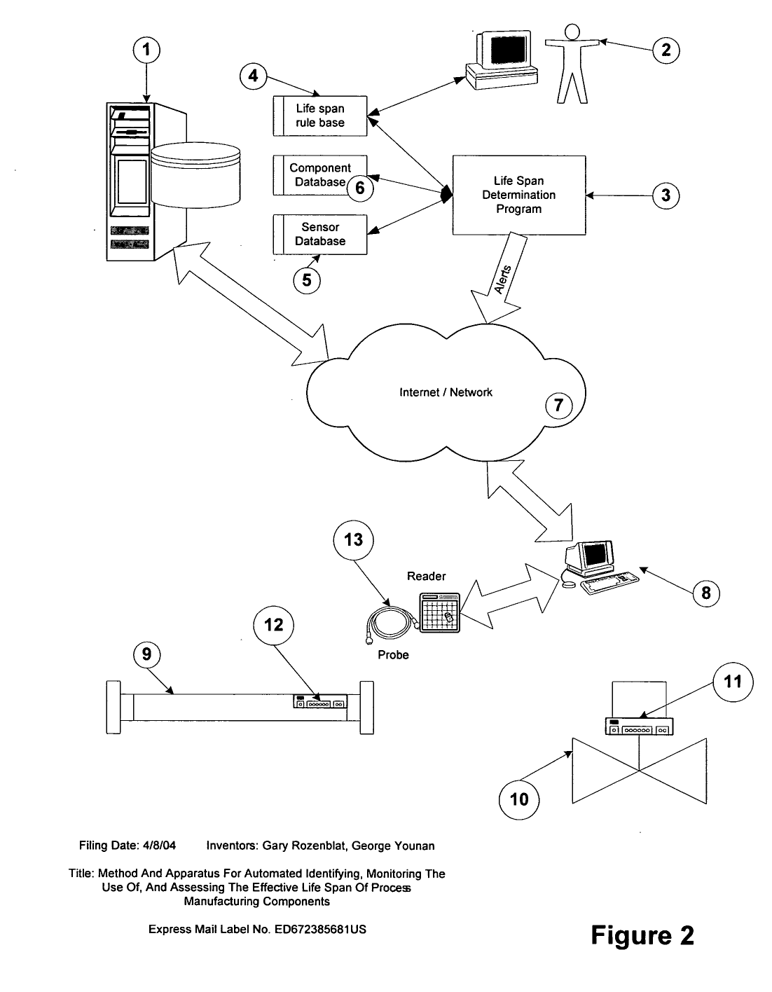

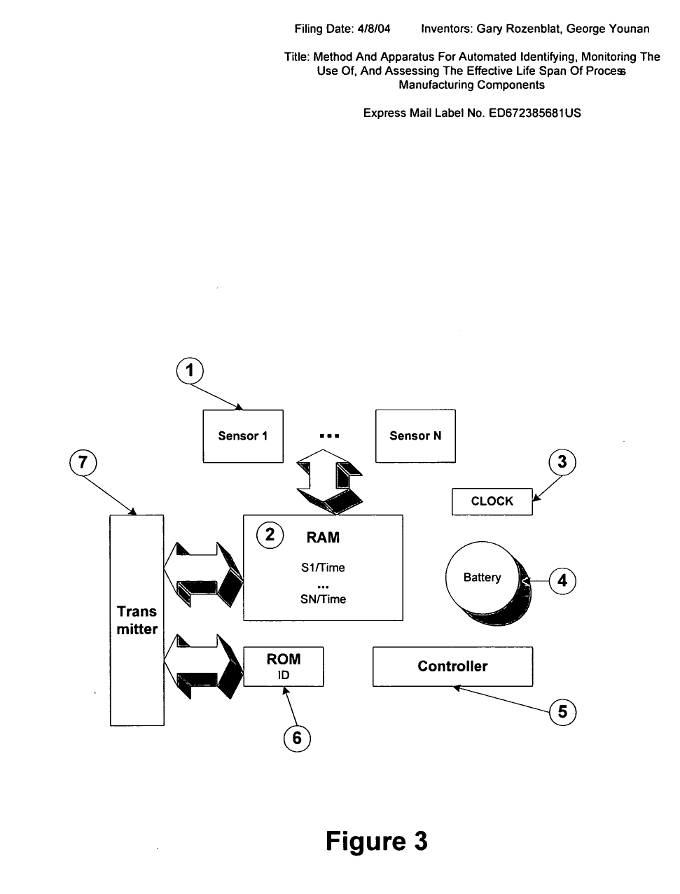

FIG. 1 shows the overall architecture of the manufacturing component tracking and life span determination system. Sensing devices FIG. 1-11 and FIG. 1-14 are attached, preferably using a tie-wrap or another secure method, to process manufacturing components FIG. 1-9 (hose assembly) and FIG. 1-10 (valve), respectively. Sensing devices FIG. 1-11 and FIG. 1-14 are preferably programmable to wake up at regular time intervals, duration of which is chosen based on the function of the component, to sense their environment via one or more sensors FIG. 3-1, such as a temperature sensor. Sensor data along with the time and date of the moment when the measurement is taken are recorded in memory FIG. 3-2 of the device. Preferably a wireless transmitter contained in sensing devices FIG. 1-11 and FIG. 1-14 sends out a radio frequency (RF) signal containing a snapshot of sensor data stored in memory FIG. 3-2 as well as the unique ID of the sensing device stored in Read Only Memory FIG. 3-6. The RF signal is received by wireless receiver FIG. 1-8 and forwarded via a public or private network to a database server where the sensor is stored in a database record along with the unique ID of the sensing device.

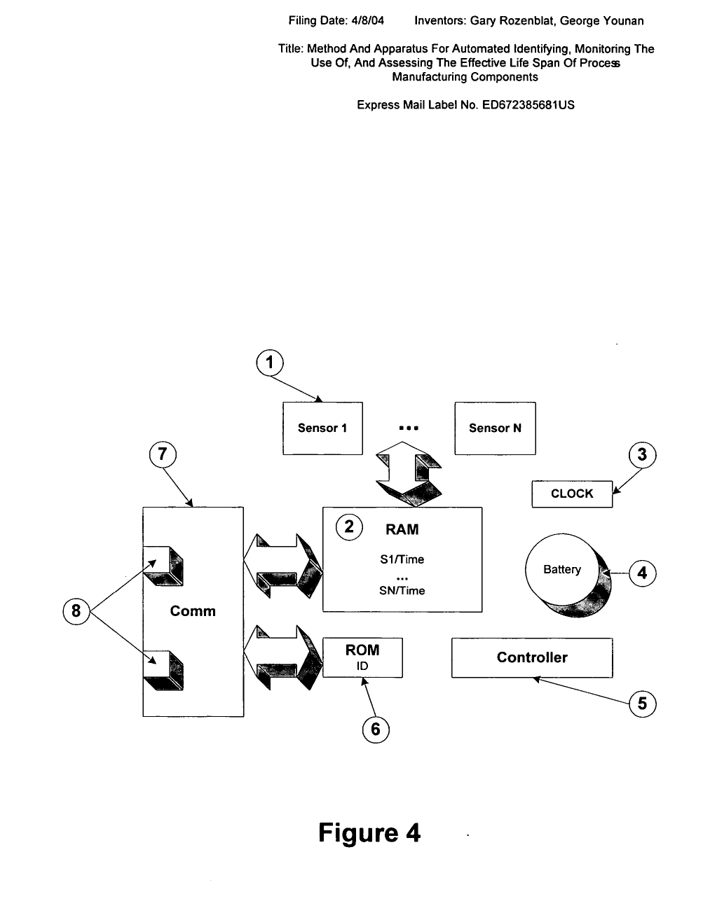

Alternatively, as shown in FIG. 2 and FIG. 4, portable reader FIG. 2-13 equipped with a probe is used to physically make contact with terminals FIG. 4-8 to communicate with the sensing device and read its unique ID stored in ROM FIG. 4-6 and sensor data stored in RAM FIG. 4-2. The reader forwards the data via a private or public network to a database server where the sensor is stored in a database record along with the unique ID of the sensing device.

The database server FIG. 1-1 is preferably a general-purpose computer equipped with sufficient storage and running standard database management software. The database contains a record or several records as is generally known in the art, for each manufacturing component of interest. The record stores important static information about the component, such as it's material of construction, manufacture date, and the unique ID FIG. 3-6 of the sensing device attached to it.

The database contains a record for every sensor reading along with its respective sensing device unique ID forwarded to it by wireless receiver FIG. 1-8 and/or portable reader/probe FIG. 2-13.

A software program, preferably with a Web browser interface provides a user interface, which allows an end user to define a set of rules to be applied to each component record to determine if the component's life span has been exceeded. The software program allows for a manual life span termination of a component, which may be due a physical inspection or failure of a component. Such life span termination becomes part of the component's record in the database.

The database contains a record for every rule. Rules are ordered in the order of importance by the user and are applied in that order. Each rule may reference any one or more static attributes of a component, any one or more or all sensory records, and other components' records. The system is thus adaptive in its nature, meaning that new decisions about component life span may incorporate the history of similar components. Rules logical query expressions on the database records. Convenience queries are pre-programmed and made available via the user interface to simply rule definition. These include “older than,” “older than average component of the same type and material,” “temperature hours maximum reached,” etc.

The application of each rule to each component is performed periodically, in the preset order. Should a rule be found true, a predetermined event, chosen via the software program interface, takes place. Such events include generating an electronic alert via email, placing a replacement order via an electronic interface to a purchasing system, etc.

1. A manufacturing component tracking, monitoring and life span determining system, comprising:
a miniature sensing device attached to component;
a reading device useable to collect sensor data from sensing device, connectable to a computer network;
a network accessible database containing component description records, sensor data records, and life span determination rules;
a computer program useable to define life span determination rules;
a computer program useable to apply life span determination rules to component and sensor data records, and performing an action if at least one rule applies to at least one component.

2. The component tracking and monitoring system of claim 1, further comprising a user interface provided with the network accessible database for the definition of life span determination rules.

3. The component tracking and monitoring system of claim 2, wherein the user interface is Web browser based.

4. The component tracking and monitoring system of claim 2, wherein the user interface provides for the rule set to be ordered in order of priority.

5. The component tracking and monitoring system of claim 2, wherein the rules may reference sensor database records.

6. The component tracking and monitoring system of claim 2, wherein the rules may reference all component database records.

7. The component tracking and monitoring system of claim 2, wherein a life span determination rule is comprised of:
a logical expression of functions referencing database record values
an action

8. The component tracking and monitoring system of claim 2, wherein the user is allowed to choose from a provided set of queries in constructing a life span determination rule expression.

9. The component tracking and monitoring system of claim 2, wherein the user is able to select and action to be executed for each rule.

10. The component tracking and monitoring system of claim 9, wherein an action is an alert email.

11. The component tracking and monitoring system of claim 9, wherein an action is an automated reorder message to electronic purchasing system.

12. The component tracking and monitoring system of claim 1, wherein a sensing device is attached to a component.

13. The component tracking and monitoring system of claim 1, wherein a sensing device is further comprised of:
at least one sensor;
a read-write memory;
a power source;
a communications module;
a clock;
read-only unique identifier;

14. The component tracking and monitoring system of claim 13, wherein a sensing device is utilizes a wireless transmitter communication module.

15. The component tracking and monitoring system of claim 13, wherein a sensing device records sensor values with date and time, periodically.

16. The component tracking and monitoring system of claim 13, wherein the sampling period of the sensing device is programmable.

17. The component tracking and monitoring system of claim 13, wherein the sensing device provides electrical communication contacts useable by tactile probe equipped reader.

18. The component tracking and monitoring system of claim 13, wherein the sensing device is further comprised of at least one temperature sensor.

19. The component tracking and monitoring system of claim 13, wherein the sensing device is further comprised of a plurality of sensors.

20. The component tracking and monitoring system of claim 13, wherein the sensing device is further comprised of at least one humidity sensor.

21. The component tracking and monitoring system of claim 1, wherein a reader is comprised of:
a communication module;
a memory;
a network interface module;
and is network accessible.

22. The component tracking and monitoring system of claim 21, wherein a reader utilizes a wireless receiving communication module.

23. The component tracking and monitoring system of claim 21, wherein a reader utilizes a tactile probe communication module.

24. The component tracking and monitoring system of claim 21, wherein a reader is a Personal Digital Assistant with tactile probe communication module.

25. The component tracking and monitoring system of claim 21, wherein a reader is able to connect to computer network to communicate with database server.

26. The component tracking and monitoring system of claim 1, further comprising a computer program, which evaluates a set of rules to component database records.

27. The component tracking and monitoring system of claim 26, wherein the computer program evaluates rules in predetermined order.

28. The component tracking and monitoring system of claim 26, wherein the computer program executes a predetermined action if a rule is found to apply to at least one component database record.
